(19) United States
(12) Patent Application Publication
(10) Pub. No.: US 2010/0065193 A1
(43) Pub. Date: Mar. 18, 2010

(54) COLD FILM APPLICATION AND SIMULTANEOUS EMBOSSING

(76) Inventors: Uwe Puschel, Heidesheim (DE); Jurgen Scholzig, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/520,800

(22) PCT Filed: Dec. 4, 2007
(86) PCT No.: PCT/EP2007/010508

§ 371 Date: Aug. 12, 2009

(30) Foreign Application Priority Data
Dec. 22, 2006 (DE) 10 2006 060 830.5

(51) Int. Cl. B32B 38/14; B44C 1/17; B32B 37/12; B44C 3/08; B32B 38/06

(52) U.S. Cl. 156/219; 156/241; 156/237; 156/390; 156/535

(57) ABSTRACT

The aim of the invention is to diversify film coating in a coating station for transferring image-providing layers from a transfer film onto a printing material. For this purpose, a film transfer module is arranged in a printing press for single-color or multicolor printing of printed sheets. One or more devices for producing a surface structure on the printing material are arranged in the printing press upstream of a film transfer module. A design from a film image and a printed image is partially or completely covered by applying layers. The additional layers serve for the protection, for drying and for producing optical effects.

### CROSS-REFERENCE TO RELATED APPLICATIONS

This patent application is the national phase of PCT/EP2007/010508, filed Dec. 4, 2007, which claims the benefit of German Patent Application No. 102006060830.5, filed Dec. 22, 2006.

### FIELD OF THE INVENTION

The invention pertains to a method and a device for transferring imaging layers from a carrier film onto sheets.

### BACKGROUND OF THE INVENTION

It is known to produce metallic layers on sheets by means of a film transfer method. For example, EP 0 569 520 B1 describes a printing material and a printing device that utilizes this material. This publication describes a sheet-processing machine that features a feeder and a delivery unit, wherein printing units and a film transfer module are arranged between these two assemblies. An adhesive pattern is applied in at least one of the printing units by means of a flatbed printing method. This adhesive pattern is applied in a cold-printing process and features a certain imaging subject. The film transfer module that is arranged downstream of the printing unit features an impression cylinder and a transfer cylinder and is provided with a film guide. This film guide is designed in such a way that a film strip or transfer film is guided from a film supply reel through the transfer gap of the film transfer module between the impression cylinder and the transfer cylinder. The film strip is wound up once again on the outlet side after it emerges from the film transfer module. The transfer film features a carrier layer, onto which imaging layers such as metallic layers, for example, of aluminum may be applied. During the transport of sheets through the printing unit, each sheet is provided with an adhesive pattern. Subsequently, the sheet is guided through the film transfer module, wherein the sheet lying on the impression cylinder is brought in contact with the film material by means of the transfer cylinder. During this process, the metallic layer that points downward is tightly connected to the regions of the sheet that are provided with adhesive. After the additional transport of the sheet, the metallic layer only adheres to the region of the patterns provided with adhesive. This means that the metallic layer is removed from the carrier film in the region of the adhesive patterns. The transfer film used in this way is rewound. The sheet is delivered in the coated state.

It is known to utilize film transfer modules of this type, for example, in printing units of printing machines. The disadvantages of known devices are that they cannot be flexibly utilized and that the consumption of transfer film is expensive. Furthermore, it is difficult to produce embossing effects.

Until now, an expensive raw material had to be used in order to produce printed products with structured surfaces. According to conventional methods, structured surfaces on a correspondingly treated sheet material or web material are initially fed to a sheet-fed printing machine by means of a roller-type sheet feeder. These structured surfaces can then be coated in-line by means of cold film application, as well as printed and, if applicable, varnished and finished or checked, marked, e.g., by means of inkjet printing and then additionally processed by means of other methods in the same machine.

It is also known to arrange an embossing unit downstream of a cold film application in a printing machine such that the surface of the sheet to be coated is also structured.

### BRIEF SUMMARY OF THE INVENTION

In view of the foregoing, a general object of the invention is to provide a method and a device for transferring an imaging layer, such as a metallic layer that is reliable, economical and precise and with which embossing effects can also be easily produced. According to the inventive method, structured surfaces can also be produced in-line.

Within a printing machine, a film coating can be applied by cold film application and the sheet can subsequently be printed and, if applicable, finished or additionally processed. The structuring may be distributed regularly or randomly and produced with a mechanical method, such as blind-embossing or with printing methods prior to the film transfer. In this case, it is possible to apply an imaging pre-coating with swellable inks, a thermal relief print, a serigraph with ink or varnish or a flock coating with expanding flocking material. Furthermore, a swellable substrate may also be used. A film transfer is subsequently carried out in-line and the substrate is then printed and, if applicable, finished in the same printing machine.

The structuring of the substrate may be produced over part of the surface or over the entire surface of the sheet or paper format, respectively. Furtheimore, it would also be possible to merely structure recessed areas of the substrate in all desired regions or under the film coating only.

If a relief is produced mechanically, e.g., by embossing methods, corresponding varnishing or printing modules can be arranged upstream of the adhesive application unit. When the structure-producing materials are applied, corresponding printing devices such as inkjet printing units, printing or varnishing units, if applicable, with drying apparatuses can be provided upstream of the application unit.

The printing machine can be equipped accordingly and operated with suitable additives. For example, compressible blankets are used in this case in order to prevent the substrate from deforming during the film transfer and during the printing process such that its surface structure remains undamaged.

When structure-producing materials are used, the structure or relief of the substrate can be produced before or after the film transfer. If applicable, this may require the input of heat or radiation, e.g., by means of a UV-radiator.

The adhesive application prior to the film transfer may take place in one or more printing units.

The advantage of this combination of processes can generally be seen in the in-line process itself because less material handling is required and the possibilities for damages are reduced accordingly. In addition, a higher added value of the finished sheet is achieved due to the integrated haptics and optics, namely also in connection with standardized materials. It is furthermore very advantageous that the applied structures such as, e.g., Braille characters are protected from separating or becoming damaged. In addition, the processing can also be realized very economically with mere finishing measures.

The pre-structuring of substrates may also be realized with calendar units or grooving devices or the like in a roller-type sheet feeder that cooperates in-line with a sheet-fed offset printing machine with one or more film transfer modules integrated therein such that an effective combination takes place in the process chain.

A steel engraving process may also be integrated into the process chain in order to allow the finishing of securities. This may be realized before or after the film transfer and in the region of or outside the film coating if the substrate is only partially coated with film.

The invention is described in greater detail below with reference to the drawings.

### BRIEF DESCRIPTION OF THE DRAWINGS

FIG. 1 is a schematic side view of an illustrative sheet-fed printing machine with a film transfer unit, and

FIGS. 2 to 4 are schematic side views of illustrative configurations of printing machines according to the present invention.

### DETAILED DESCRIPTION OF THE INVENTION

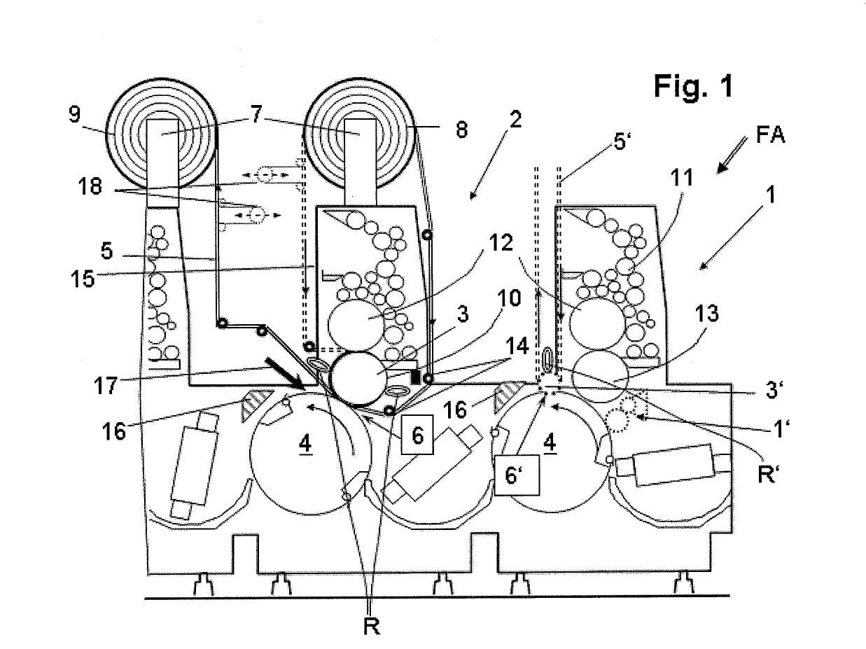

Referring to FIG. 1 of the drawings, a sheet-processing machine, namely a printing machine that consists of at least two printing units, is shown. In a first step, a sheet to be coated is provided with an image adhesive pattern in the application unit 1. A printing unit of an offset printing machine with inking and dampening units 11, a printing plate on a plate cylinder 12, an offset blanket or blanket cylinder 13 and an impression cylinder 4 may be used for this purpose. It would also be possible to utilize application units in the of flexographic printing or varnishing units. The adhesive can also be applied in two application units 1 in order to improve its effect on different substrates.

In a second step, a transfer film 5 is guided through a transfer nip 6 together with the sheet and pressed against the sheet. A film transfer module 2 used for this purpose may consist of a printing unit, a varnishing module, a base unit or another type of processing unit of a sheet-fed offset printing machine. The transfer nip 6 in the film transfer module 2 is formed by a transfer cylinder 3 and an impression cylinder 4. The transfer cylinder 3 may correspond to an offset blanket or plate cylinder of a generally known offset printing unit or a varnishing module of a sheet-fed offset printing machine. A strip guide for transfer films 5 is illustrated within the film transfer module 2.

A film supply reel 8 is assigned to the film transfer module 2 on the side of the sheet feeder. The film supply reel 8 features a rotary drive 7. The rotary drive 7 can be used for ensuring a continuous, controlled feed of the transfer film 5 to the film transfer module 2 and therefore is configured in a controllable fashion. Furthermore, control equipment 14 such as deflection and tensioning rollers, pneumatically actuated control elements, directional baffles or the like can be provided in the region of the film feed and the film delivery unit. This makes it possible to always guide the film strip of transfer film 5 in a plane fashion without distortions and to maintain the tension of the film strip constant relative to the transfer cylinder 3.

The transfer film 5 can be guided around the transfer cylinder 3, wherein the transfer film 5 can be advantageously fed to and delivered from the transfer nip 6 from one side of the film transfer module 2 only (see illustration drawn with broken lines). In addition, the transfer film 5 may also be fed to and delivered from transfer nip 6 such that it extends past the transfer cylinder 3 tangentially or is looped around said transfer cylinder at a small angle along the circumference only. The transfer film 5 is fed to one side of the film transfer module for this purpose, and delivered at the opposite side of the film transfer module 2. A film collecting reel 9 for winding used film material is illustrated on the outlet side of the printing unit. The controllable rotary drive 7 can also be provided in this case.

Additionally, supplementary dryers 16 can be arranged in the region of the adhesive application and the film transfer. This makes it possible to pre-dry the adhesive layer by means of a first dryer 16 (intermediate dryer I), e.g., a UV-dryer, such that the adhesion of the useful surface of the transfer film 5 is improved. Furthermore, the adhesive effect of the embossed useful layer on the sheet can be improved with a second dryer 16 (intermediate dryer II) that additionally accelerates the final drying of the adhesive.

The surface of the transfer cylinder 3 is provided with a press covering 10 in the form of compressible damping elements for the transfer of the imaging, e.g., useful layer from the transfer film 5 onto the sheet in the transfer nip 6 between the transfer cylinder 3 and the impression cylinder 4.

According to FIG. 1, the cold film application can also be carried out in an integrated film transfer module FA. In this case, the film feed is also integrated into the same printing unit, in this case the application unit 1, such that the adhesive application and the film transfer are carried out in two successive gaps on the same impression cylinder 4.

According to an aspect of the present invention, structured surfaces can also be produced in-line. A structured surface with film coating should be produced in a printing machine in one process. A regularly or randomly distributed structuring can be realized in one fabrication step prior to the film transfer by means of a mechanical method or printing methods.

The mechanical methods are generally known as embossing methods. In this case, an embossing unit is arranged upstream of the film transfer module FA. If a relief is produced mechanically, e.g., by means of embossing methods, corresponding varnishing or printing modules are arranged upstream of the application unit 1 for the adhesive.

With respect to the utilization of printing methods, an imaging pre-coating is used, in which mediums such as swellable inks, a thermal relief print, a serigraph with ink or varnish or a flock coating with expanding flocking material can be applied. If structure-producing materials are applied, corresponding printing devices such as inkjet printing units, printing or varnishing units, if applicable, with dryers must be arranged upstream of the application unit.

It is also possible to utilize a substrate that is subjected to local swelling by means of chemical effects or radiation effects.

Depending on the type of pre-treatment, a substrate that is thereby pre-treated within a printing machine can still be planar or already have a certain surface structure.

Subsequently, a film transfer is carried out in-line. If the structure is not yet realized on the substrate, it can now be produced under the influence of radiation or heat. After the film transfer and, if applicable, the process for producing the surface structure, the substrate is printed and, if applicable, finished in-line in the same printing machine.

The structuring of the substrate may be realized over part of the surface or over the entire surface of the sheet or paper format, respectively. Furthermore, recessed regions that are distributed over the entire substrate may be structured, namely in the region of the film coating, as well as outside the film coating.

The printing machine must be equipped accordingly and operated with suitable additives. For example, compressible blankets are used in this case in order to prevent the substrate from deforming during the film transfer and during the printing process such that its surface structure remains undamaged.

If structure-producing materials or mediums are used, the structure or relief of the substrate can be produced before or after the film transfer. This may require, if applicable, the supply of heat or radiation, e.g., by means of a UV-radiator such as by a dryer.

Calendering or grooving devices or the like may also be considered for the mechanical pre-structuring of the substrates. These units can be integrated into a roller-type sheet feeder that is arranged upstream of the printing machine. A device that operates in accordance with the steel engraving process may also be integrated in order to allow the finishing of securities.

Several film transfer modules may also be integrated into the printing machine.

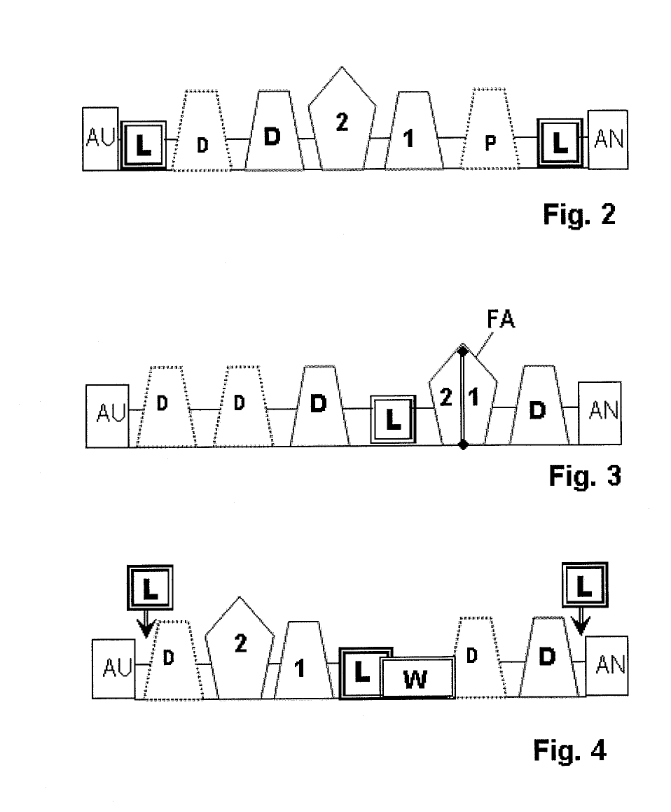

FIGS. 2 to 4 schematically show different options for arranging the coating module 2 and the application unit 1 or film transfer module FA in a printing machine in order to carry out the described method for producing structured substrates. In all configurations shown, one or more varnishing modules L may be arranged in the printing machines illustrated in the figures downstream of a feeder AN and upstream of film transfer modules FA or 1, 2 and printing units D in order to realize the pre-coating of sheets. In the arrangements shown, one or more varnishing modules L may be provided upstream of a delivery unit AU in order to apply one or more transparent and clear, glossy or colored cover layers. The normal combination consisting of an application unit 1 and a coating module 2 or, alternatively, an integrated film transfer module FA may be provided at all positions at which a film transfer is to be carried out. If several film transfer positions are configured, it is particularly advantageous to utilize the integrated film transfer modules FA.

FIG. 2 shows a basic configuration of the inventive printing machine. A varnishing module L, a preparation module P, an application unit 1 and a coating module 2 are successively arranged downstream of a sheet feeder AN of the sheet-fed printing machine. Printing units D of the sheet-fed printing machine are arranged downstream of the coating module 2. A varnishing module L and a sheet delivery unit AU complete the configuration. Such a printing machine makes it possible to pre-coat a sheet in the varnishing module L in order to improve its surface or consistency. Alternatively, a mechanical structuring can be produced in the preparation module by means of embossing, e.g., blind-embossing, or grooving.

A printing pre-treatment for producing a structuring may be carried out in the preparation module P, wherein printing inks, flocking mediums or thermal relief media are applied in this case. Offset printing, screen printing, flexographic printing, inkjet printing, transfer printing or the like may be considered as printing methods.

The structuring of the substrate can be produced in the preparation module P in combination with the varnishing module L that can also be used as a flexographic printing unit by exposing the substrate to radiation or heat. Furthermore, a swellable substrate can be treated at this location in order to produce a structuring by applying structured heat or radiation.

The treatment of the substrate can be continued once the film transfer has taken place. A dryer suitable for producing the structuring may be provided for this purpose upstream of the printing units and downstream of the coating module 2. A protective varnish can ultimately be applied after the color printing in order to protect the surface.

In FIG. 3, a printing unit D is arranged downstream of the sheet feeder AN. An integrated film transfer module FA is arranged downstream of the printing unit D and a varnishing module L is arranged downstream of the film transfer module FA. Different printing units D, as well as a delivery unit AU, are provided downstream of this varnishing module.

In this configuration, a printing unit D is provided for pre-treating the structuring. In this case, the pre-treatment may also be carried out mechanically or with printing mechanisms. The subsequent treatment of the substrate for producing the structuring can then be carried out in the varnishing module L that is arranged downstream of the film transfer module FA.

FIG. 4 shows an additional refinement variation of the printing machine that consists of two machine groups. The printing machine once again features the sheet feeder AN, wherein a varnishing module L that is followed by one or more printing units D may be assigned to the sheet feeder. A sheet turning arrangement W is provided downstream of the last printing unit D of the first machine group.

The sheet turning arrangement W is provided for turning sheets that were printed or coated on one side in the first machine group along their path through this sheet-fed printing machine such that their former unprinted underside becomes the upper side that can subsequently be printed, coated, heat-treated or mechanically deformed.

In the configuration shown, an application unit 1 and a coating module 2 are arranged downstream of the sheet turning arrangement W. If applicable, several other printing units D and an optional varnishing module L are arranged downstream thereof and upstream of the sheet delivery unit AU.

In such a printing machine, each sheet can be initially coated and printed with one or two colors on its rear side before it is turned, coated with an imaging film layer, subsequently printed once again in a multi-colored fashion and, if applicable, varnished. One example for this is greeting cards with decorative inserts of metal foil on the image side. In this case, the structuring or preparation for the structuring is carried out in a varnishing module L that is arranged directly downstream of the sheet turning arrangement W.

In this case, the machine can be configured as follows:
A pre-treatment unit in the form of a varnishing module L, a printing unit D or a preparation module P is arranged upstream of each film transfer module FA or each application unit 1.
A rough or porous substrate can be pre-coated in an additional first printing unit/varnishing module in order to homogenize and optically normalize its surface and internal structure. An intermediate dryer can be used after the coating process.
In the aforementioned pre-treatment units, the substrate is subjected to a mechanical or printing pre-treatment in order to produce or prepare the desired structuring.
Adhesive is applied in a downstream first printing unit/application unit 1. The adhesive application may also be carried out twice in order to produce a sufficient adhesive layer. The film transfer is carried out in the second printing unit/coating module 2.
After the film transfer, a subsequent treatment can be carried out in a separate varnishing module L, printing unit D or preparation module P in order to produce or stabilize the structuring of the substrate. Subsequently, the sheet can be once again printed and varnished.
During the film transfer downstream of a sheet turning arrangement W, one side of the substrate is initially coated or printed. After the sheet has been turned, the rear side of the sheet is pre-treated for the structuring before the film transfer takes place. The sheet can then be once again printed/varnished.
After the film transfer, a subsequent treatment can be once again carried out in a separate module.
The sheet can then be once again printed and varnished.
It is also possible to arrange the pre-treatment devices in connection with the sheet feeder AN. In this case, the sheet feeder may be in the form of a roller-type sheet feeder. The pre-treatment can then be carried out continuously prior to the cutting of the sheet, namely when the substrate is pulled off the substrate roller.
It is also possible to arrange two or more film transfer devices in a printing machine. These devices may be alternatively realized in the form of permanently installed or mobile devices.

The configurations shown merely represent examples. A person skilled in the art can easily find other optional applications during the course of modularizing the film transfer modules in the above-described fashion.

### LIST OF REFERENCE SYMBOLS

1 Application unit
2 Film transfer module
3 Transfer cylinder
4 Impression cylinder
5 Transfer film/film strip
6 Transfer nip
7 Roller drive
8 Film supply reel
9 Film collecting reel
10 Press covering
11 Inking/dampening unit
12 Plate cylinder
13 Offset blanket cylinder
14 Guiding device
15 Protective cover
16 UV-dryer
17 Monitoring system
18 Dancer roll
D Printing unit
W Turning arrangement
AN Sheet feeder
AU Sheet delivery unit
FA Integrated film transfer module
L Varnishing module

1-27. (canceled)

28. A method for producing a printed image on a sheet incorporating the transfer of an imaging layer from a transfer film comprising the steps of:
feeding a sheet having an essentially non-structured surface to a sheet processing machine;
subjecting the sheet to a pre-treating processing step for producing an altered surface structure on the sheet;
applying an adhesive onto the altered surface structure of the sheet in at least one application unit of a film transfer module of the sheet processing machine;
subsequently transferring a film image comprising at least a portion of the imaging layer from the transfer film onto the sheet in a coating module; and
subsequently subjecting the sheet to a further processing step.

29. The method according to claim 28 wherein the further processing step comprises application of a film coating and further including the step of subsequently applying a printed image using at least one printing ink that at least partially incorporates the film image.

30. The method according to claim 28, further including the step of applying a base coating to the sheet prior to the application of the film image.

31. The method according to claim 30, wherein the base coating of the sheet is realized with a medium having an adhesive strength adapted relative to the adhesive.

32. The method according to claims 28, wherein the pre-treating processing step comprises acting upon the sheet mechanically with a rotative embossing method from the group consisting of blind-embossing, calendaring, a grooving treatment, or a mechanical deformation in an embossing unit in a roller-type sheet feeder arranged upstream of the sheet processing machine.

33. The method according to claim 28, wherein the pre-treating processing step comprises application of a structured image that corresponds to a desired embossing structure and includes mediums of variable volume.

34. The method according to claim 33, wherein the structured image is applied using a printing method from the group consisting of offset printing, flexographic printing, gravure printing or screen printing

35. The method according to claim 33, wherein the structured image is applied using a thermal relief method

36. The method according to claim 33, wherein the structured image is applied using a flock coating comprising an expanding flocking material.

37. The method according to claim 28, wherein the pre-treating processing step comprises application of a pre-coating and the pre-coating is subsequently subjected to a heat treatment or a radiation treatment in order to produce the altered surface structure, wherein the heat treatment or radiation treatment occurs either before or after transferring of the film image.

38. The method according to claim 28, wherein the further processing step comprises applying a printed image and subsequently applying a varnish to the sheet.

39. The method according to claim 28, wherein the further processing step comprises a drying process.

40. A device for producing a printing image on a sheet incorporating the transfer of an imaging layer from a transfer film comprising:
a film transfer module for transferring the imaging layer from the transfer film onto the sheet; the film transfer module including an application unit for producing an imaging coating on the sheet with an adhesive and a coating module for transferring the imaging layer from the carrier film onto the sheet in a transfer nip between an impression cylinder and a press-roller, wherein the transfer film and the sheet can be jointly guided through the transfer nip such that a coated side of the transfer film is in contact with the sheet and the imaging layer is transferable onto the sheet; and
a pre-treating unit for producing a surface structure on the sheet arranged upstream of the film transfer module such that the application unit applies the imaging coating and the coating module applies the film image onto the surface structure of the sheet.

41. The device according to claim 40, wherein the pre-treating unit is a varnishing module, a printing unit or a preparation module for mechanically producing the surface structure in the sheet.

42. The device according to claim 40, wherein the pre-treating unit is a varnishing module or printing unit for producing a structured image consisting of mediums of variable volume on the sheet and further including a subsequent processing unit for producing the surface structure on the sheet, the further processing unit being arranged upstream or downstream of the film transfer module.

43. The device according to claim 42, wherein the subsequent processing unit comprises a dryer.

44. The device according to claim 40, further including a plurality of printing units for producing a colored imprint on the sheet.

45. The device according to claim 40, further including a plurality of dryers.

46. The device according to claim 40, further including a roller-type sheet feeder equipped for feeding sheets, wherein the pre-treating unit is incorporated in the roller-type sheet feeder.
